(19) United States
(12) Patent Application Publication
(10) Pub. No.: US 2010/0292379 A1
(43) Pub. Date: Nov. 18, 2010

(54) PVC resin composition and products made of the same

(75) Inventors: Dein-Run Fung, Taipei (TW); Te-Chao Liao, Taipei (TW); Shih-Hsien Wang, Taipei (TW)

Correspondence Address: BACON & THOMAS, PLLC, 625 SLATERS LANE, FOURTH FLOOR, ALEXANDRIA, VA, 22314-1176, US

(73) Assignee: NAN YA PLASTICS CORPORATION, Taipei (TW)

(21) Appl. No.: 12/588,942

(22) Filed: Nov. 3, 2009

(30) Foreign Application Priority Data
May 12, 2009 (TW) 098115671

(51) Int. Cl. C08K 3/22; C08K 5/12; C08K 5/09; C08K 5/13

(52) U.S. Cl. 524/296; 524/430; 524/322; 524/384

(57) ABSTRACT

A PVC resin composition having high flame retardancy and low smoke generation comprises a formula including a PVC resin, inorganic powders, a additive, a toughening agent, a coupling agent and an initiator mixed by proportion, wherein the initiator cooperates with the coupling agent to improve a binding effect of the inorganic powders inside the PVC resin composition to endow a PVC product if made of the composition to provide with excellent tensile strength and elongation and enable the product to perform high flame retardancy and low smoke generation during combustion.

### BACKGROUND OF THE INVENTION

1. Field of the Invention

The present invention relates to a resin composition, and more particularly, to a PVC resin composition of high flame retardancy and low smoke generation and to a PVC product made of such PVC resin composition possessing both excellent tensile strength and outstanding elongation.

2. Description of Prior Art

PVC resin has its chlorine content as high as 56%, meaning that its LOI (Limit Oxygen Index) is 45, which contributes to the flame retardancy of PVC resin. However, PVC resin, in practical use, has to be added with a certain proportional amount of a plasticizer and other additives. These added plasticizer and additives can significantly reduce the overall chlorine content and in turn the flame retardancy of PVC resin.

For remedying the above problem, the existing technology uses organic brominated or phosphorus flame retardants or flame-retardant plasticizers, together with antimony compounds (e.g. antimony trioxide) to improve the flame retardancy of PVC resin and further maintain such PVC resin having LOI greater than 45, whereas such an approach has its defect. That is, in fire, PVC resin containing an organic brominated or phosphorus flame retardant or a flame-retardant plasticizer tends to emit thick smoke considerably, with a smoke density (Ds) up to 300 to 500 Ds_{(non-flame)}, being not only pollutant to the environment, harmful to human health, and damaging to equipments, but also hindering fire fighting. Therefore, it has been recognized as an ultimate goal for the related manufacturers to provide PVC resin for practical use with high flame retardancy and low smoke generation.

An alternative conventional solution is to add a large quantity of inorganic powders in PVC resin directly for supporting flame retardancy and smoke restraint. Among others, inorganic powders containing aluminum hydroxide, magnesium hydroxide, zinc compounds, molybdenum compounds, montmorillonite or mica may be added into PVC resin, and the resultant PVC resin is proven as presenting high flame retardancy and low smoke generation, with its LOI greater than 45, and Ds_{(non-flame)} below 150. Nevertheless, the substantial addition of the inorganic powders in PVC resin reflects significant deterioration of mechanical properties, particularly tensile strength and elongation, on PVC products made of such PVC resin composition.

### SUMMARY OF THE INVENTION

Hence, the primary objective of the present invention is to provide a PVC resin composition, which benefits from a coupling agent and an initiator contained therein in high binding ability of inorganic powders inside the PVC resin composition, so as to not only have high flame retardancy and low smoke generation, but also ensure good mechanical properties of PVC products made therefrom, thus successfully improve the conventional PVC products that suffer from significantly deteriorated mechanical properties due to the addition of inorganic powders in the PVC resin as the material thereof.

The PVC resin composition of the present invention by weight of the composition contains 20% to 60% of PVC resin, 5% to 70% of inorganic powders, 5% to 10% of finishing agents comprising one or more agents selected from the group consisting of a heat stabilizer, a plasticizer, a lubricant, an anti-oxidant, an antistatic agent, an ultraviolet absorber and a coloring agent, 1% to 50% of a toughening agent, 0.1% to 5% of a coupling agent and at most 5% of an initiator.

Therein, the PVC resin composition of the present invention takes the advantage of the introduction of the coupling agent and the initiator that, during the mixing and gelatinization process for making the PVC resin composition, the function group of the introduced coupling agent is grafted to the surface of the inorganic powders, and modifies the surface of the inorganic powders, while the surface-modified inorganic powders, with the assistance of the initiator, perform chemical covalent grafting with rubber or thermal plastic elastomer, as the toughening agent, and with the molecular chain of PVC, thereby improving the binding of the inorganic powders inside the PVC resin composition, endowing the PVC resin composition of the present invention with high flame retardancy and low smoke generation, and in turn ensuing good mechanical properties of PVC products made of the PVC resin composition of the present invention.

In the formula of the PVC resin composition of the present invention, part of the components (such as the toughening agent, the inorganic powders, the coupling agent, and the initiator) may be mixed and gelatinized beforehand and then further made into a masterbatch. The obtained masterbatch is so good for mixing with PVC resin and the other finishing agents that the mixture if followed by a gelatinization process is suitably gelatinized and finally produced as the PVC resin composition of the present invention. And, PVC products if made from the PVC resin composition of the present invention provide with the distinguishing feature of high flame retardancy and low smoke generation as well as excellent mechanical properties.

### BRIEF DESCRIPTION OF THE DRAWINGS

FIG. 1 is shows the microstructure of a PVC resin composition of the present invention.

### DETAILED DESCRIPTION OF THE PREFERRED EMBODIMENT

According to the present invention, a PVC resin composition based on the total weight of the resin composition contains 20% to 60% of PVC resin, 5% to 70% of inorganic powders, 5% to 10% of finishing agents comprising one or more agents selected from the group consisting of a heat stabilizer, a plasticizer, a lubricant, an anti-oxidant, an antistatic agent, an ultraviolet absorber and a coloring agent, 1% to 50% of a toughening agent, 0.1% to 5% of a coupling agent and at most 5% of an initiator.

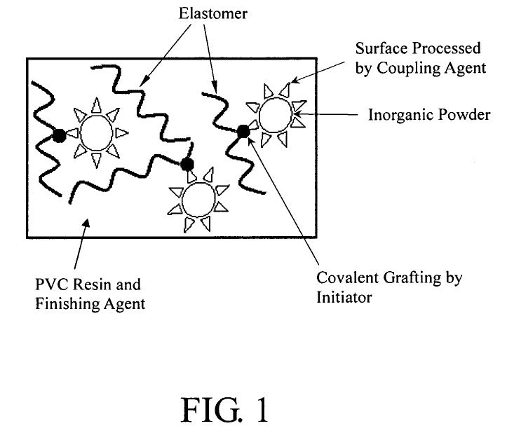

Referring to FIG. 1, the PVC resin composition of the present invention has the advantage of introduction of the coupling agent and the initiator. As a result, during the mixing and gelatinization process for making the PVC resin composition, the function group of the introduced coupling agent is grafted to the surface of the inorganic powders and modifies the surface of the inorganic powders. With the assistance of the initiator, the surface-modified inorganic powders shall perform chemical covalent grafting with the toughening agent (e.g., rubber or thermal plastic elastomer) and with the molecular chain of PVC, thereby improving the binding of the inorganic powders inside the PVC resin composition.

Consequently, the PVC resin composition of the present invention is advantaged by possessing high flame retardancy and low smoke generation, and PVC products made from the disclosed PVC resin composition are endowed with excellent mechanical properties.

The PVC resin composition of the present invention refers to a thermoplastic polymer polymerized from vinyl chloride (VC) monomer, with an average DP (Degree of polymerization) ranging between 400 and 2000. Said PVC resin composition may be prepared by suspension polymerization, bulk polymerization, emulsion polymerization or solution polymerization. It is to be noted that the type and preparation of the PVC resin referred in the present invention may be any one or any combination of those recited above.

The inorganic powders acting as a flame retardant provide with an average powder diameter ranging between 0.01 and 50 μm to endow the disclosed PVC resin composition with flame retardancy and smoke restraint. The inorganic powders may be selected from the group consisting of aluminum compounds, magnesium compounds, zinc compounds, boron compounds, calcium compounds, molybdenum compounds, antimony compounds, silicon compounds, iron compounds, copper compounds, tin compounds, titanium compounds, mica, hydrotalcite, montmorillonite, and combination thereof.

Therein, the aluminum compounds include aluminum hydroxide, aluminum oxide, aluminum oxalate, aluminum phosphate, aluminum sulfate, and aluminum carbonate. The magnesium compounds include magnesium hydroxide, magnesium oxide, magnesium phosphate, magnesium sulfate and magnesium carbonate. The zinc compounds include zinc borate, zinc oxide, zinc sulfate and zinc acetylacetonate. The boron compounds include boron oxide, ammonium pentaborate, boron phosphate, boric acid, sodium borate and borates. The calcium compounds include calcium borate, calcium carbonate, calcium hydroxide and calcium acetylacetonate. The molybdenum compounds include molybdenum trioxide, calcium molybdate, zinc molybdate, ammonium octamolybdate and melamine octamolybdate. The antimony compounds include antimony trioxide, antimony pentoxide and antimonates. The silicon compounds include silica, silicone, silica gel and silicates. The iron compounds include ferric oxide, ferrocene, benzoyl ferrocene and iron acetylacetonate. The copper compounds include copper oxide, copper chloride, copper bromide and copper oxalate. The tin compounds include zinc stannate and hydrated zinc stannate. The titanium compounds include titanium dioxide and aluminium titanate.

The inorganic powders preferably take from 5 to 70% by weight of the PVC resin composition of the present invention. When the added amount thereof is lower than 5% by weight of the composition, the desired flame retardancy becomes unachievable. When the added amount thereof is higher than 70% by weight of the composition, the mechanical properties, including tensile strength and elongation, of the PVC products made of the composition can be adversely affected.

For giving the disclosed PVC resin composition with better flame retardancy and acceptable smoke restraint, the inorganic powders added may be selected from aluminum compounds and magnesium compounds. For giving the disclosed PVC resin composition with better smoke restraint and acceptable flame retardancy, the inorganic powders added may be selected from the group consisting of zinc compounds, molybdenum compounds, montmorillonite and mica.

The toughening agent serves to improve the toughness of the disclosed PVC resin composition of the invention, and may be a material selected from chlorided polyethylene (CPE) elastomer, PVC-rubber graft copolymer, PVC-rubber copolymer, thermoplastic polyurethane (TPU) elastomer, polyurethane elastomer, ethylene-vinyl-acetate (EVA) elastomer, acrylic resin (ACR) elastomer, acrylonitrile-butadiene-styrene (ABS) elastomer, methyl-butadiene-styrene (MBS) elastomer, styrene-butadiene-styrene (SBS) elastomer, styrene-isoprene-styrene (SIS) elastomer; styrene-ethylene-butylene-styrene (SEBS) elastomer, styrene-ethylene-propylene-styrene (SEPS) elastomer, thermoplastic olefin elastomer (TPO or TPE), thermoplastic dynamic vulcanized olefin elastomer (TPV), acrylonitrile-butadiene-rubber (NBR), polymethyl methacrylate (PMMA) resin, ethylene propylene diene monomer (EPDM), and any combination thereof.

The coupling agent modifies the surface of the inorganic powders, including a silane-base coupling agent or a titanate-based coupling agent, used either solely or in combination.

Therein, the silane coupling agent is selected from the group consisting of 3-mercaptopropyltrimethoxysilane, 2-vinylphenyl-ethyl-trimethoxysilane, N-β-aminoethyl-γ-aminopropyl-trimethoxysilane, β-(3,4-epoxycyclohexyl)ethyltrimethoxysilane, γ-(glycidoxypropyl)trimethoxysilane, phenyltrimethoxysilane, vinyltrimethoxysilane, vinyltriethoxysilane and dimethyldimethoxysilane, either used solely or in combination.

The titanate coupling agent is selected from the group consisting of isopropyl triisostearoyl titanate, isopropyl trioctanoyl titanate, isopropyl tri(dioctylpyrophosphate)titanate, isostearoyl tri(dimethylpropylene)isopropyl titanate, isopropyl tri(N,N-2-aminoethyl)titanate, isopropyl tri(dodecylbenzenesulfonic) titanate, isopropyl isostearamidopropyl titanate, isopropyl tri(di(2-Ethylhexyl)phosphate)titanate, isopropyl tricumylphenyl titanate, di(di(2-ethylhexyl)phosphate)tetraisopropyl titanate, di(di(dodecyl)phosphate)tetra(2-ethylhexyl)titanate, di(di(tridecane)phosphate tetra(2,2-dimethyldi(allyloxy)-1-butyl)titanate, di(dioctylpyrophosphato)acetate titanate and di(dioctylpyrophosphato)ethylene titanate, either used solely or in combination.

The initiator cooperates with the coupling agent to improve the binding of the inorganic powders inside the PVC resin composition of the invention. The initiator may include a peroxide initiator, an azo-compound initiator or a redox-system initiator, either used solely or in combination.

Therein, the peroxide initiator is selected from the group consisting of dicumyl peroxide (DCP), 2,5-dimethyl-2,5-bis(t-butylperoxy)-hexyne (DBPH), 1,1-di-t-butylperoxy-3,3,5-trimethyl-cyclohexane, t-butylcumyl peroxide, 4,4-di-t-butylperoxy-n-butyl valerate, dibenzoyl peroxide (BPO), bis(2,4-dichlorobenzoyl)peroxide (DCBP), tert-butyl peroxypivalate (BPP), dicyclohexyl peroxydicarbonate (DCPD), potassium persulfate (KSP) and ammonium persulfate (ASP), either used solely or in combination.

The azo-compound initiator is selected from 2,2′-Azo-bis-isobutyronitrile (AIBN) and azobisisoheptonitrile (ABVN), either used solely or in combination.

The oxidant for the redox-system initiator may include hydrogen peroxide, persulfate, hydroperoxide, alkyl peroxide or acetyl peroxide.

The reducing agent for the redox-system initiator may be selected from the group consisting of alcohol, amine, oxalic acid, glucose, tertiary amine, naphthenate, thiol and organic metal compounds, either used solely or in combination.

The additives serve to improve the processing properties, mechanical and electrical properties, thermal properties and light stability of the disclosed PVC resin composition of the invention, as long as the disclosed PVC resin composition of the invention presents desired flame retardancy and smoke restraint. The finishing agent may comprise one or more agents selected from the group consisting of a heat stabilizer, a plasticizer, a lubricant, an anti-oxidant, an antistatic agent, thermal and light stabilizers, an ultraviolet absorber, a filler (may be in granule form) and a colorant.

Therein, the heat stabilizer is selected one or more from ZnSt, CaSt, BaSt, CdSt, PbSt, an organic tin-based heat stabilizer (e.g. sulfur-containing organo tin or organotin-carboxylate), a lead salt heat stabilizer (e.g. tribasic lead sulfate, Dibasic lead phosphite or dibasic lead stearate), a rare earth heat stabilizer (lanthanum, cerium, praseodymium, and neodymium, wither in the form of a simple or a complex), a phosphate heat stabilizer, an epoxide heat stabilizer (e.g. soybean oil epoxide or epoxy ester) and a polyol heat stabilizer (e.g. pentaerythritol, xylitol or mannitol).

The plasticizer is selected one or more from dioctyl phthalate (DOP), n-hexyl-n-decyl phthalate (NHDP), n-octyl-ndecyl phthalate (NODP), di(isononyl) phthalate (DINP), di(isodecyl)phthalate (DIDP), diundecyl phthalate (DUP), di(isotridecyl)phthalate (DTDP), di-2-ethylhexyl adipate (DOA), di-n-oetyl-n-ducyl adipate (DNODA), diisononyl adipate (DINA), di-2-ethylhexyl azelate (DOZ), di-2-ethylhexyl sebacate (DOS), trioctyl trimellitate (TOTM), trioctyl phosphate (TOP), tricresyl phosphate (TCP), aliphatic polyester plasticizer or aliphatic polyol plasticizer.

The lubricant is selected from the group consisting of a stearic acid lubricant, a fatty acid lubricant, an alkanol amide lubricant, an ester lubricant, a metal soap lubricant and an organic silicon lubricant, either used solely or in combination.

The anti-oxidant may include a hindered phenol anti-oxidant or a phosphite anti-oxidant, either used solely or in combination.

The antistatic agent is selected from a surfactant, a conductive fibre, a conductive carbon or metal powders, either used solely or in combination.

The ultraviolet absorber is selected from the group consisting of benzophenone, benzotriazole and a hindered amine ultraviolet absorber, either used solely or in combination.

The colorant may be selectively implemented according to the desired color of the product and is selected from an organic coloring agent or an inorganic coloring agent, either used solely or in combination.

The PVC resin composition of the present invention is applicable to production of PVC products, such as building materials, pipes, mechanical parts, electric cords, electric cables, adhesive tape, plastic leather and fabric.

While some embodiments and comparative examples will be described below for illustrating the effects of the present invention, it would be understood that the present invention should not be limited by the embodiments.

### Example 1

From the Table 1, one hundred weight parts of the PVC resin (of an average degree of polymerization at 1000), 0.5 weight parts of the calcium-zinc stabilizer, 20 weight parts of the trioctyl trimellitate (TOTM) plasticizer, 0.2 weight parts of polyethylene wax as the lubricant, 25 weight parts of chlorided polyethylene elastomer as the toughening agent, an approximate amount of the inorganic powders (including 100 weight parts of aluminum hydroxide, 5 weight parts of zinc borate, 5 weight parts of molybdenum trioxide and 2 weight parts of montmorillonite), 2 weight parts of vinyltrimethoxysilane as the coupling agent, 0.1 weight parts of dicumyl peroxide initiator, were weighted and put together into a vertical mixer for a mixing process under 60 rpm×10 min and the room temperature.

The mixture was then put into a kneader for a gelatinization process under 160° C.×45 rpm×25 min. After gelatinization, the gelatinized mixture was taken out from the kneader, and put into a single-screw extruder for a forming process under 160° C. The extruded mixture was then process by compulsory air-cooling and finished as a PVC resin composition.

Physical properties of the obtained PVC resin composition were measured, including tensile strength, elongation, flame retardancy (LOI) and smoke generation, as provided in Table 2.

### Example 2

From Table 1, the PVC resin formula used was the same as that of Example 1, except that 25 weight parts of chlorided polyethylene elastomer as the toughening agent, an approximate amount of inorganic powders (including 100 weight parts of aluminum hydroxide, 5 weight parts of zinc borate, 5 weight parts of molybdenum trioxide and the 2 weight parts of montmorillonite), 2 weight parts of vinyltrimethoxysilane as the coupling agent, and 0.1 weight parts of dicumyl peroxide initiator was herein mixed beforehand and then gelatinized to form a masterbatch under the processing conditions as shown in Table 2.

The obtained masterbatch was mixed by proportion with 100 weight parts of the PVC resin (average DP of 1000), 0.5 weight parts of the calcium-zinc stabilizer, 20 weight parts of the trioctyl trimellitate (TOTM) plasticizer and 0.2 weight parts of polyethylene wax as the lubricant. The mixture was gelatinized to form the PVC resin composition under the processing conditions as shown in Table 2.

Physical properties of the obtained PVC resin composition were measured and are reflected in Table 2.

### Example 3

From Table 1, except that the dicumyl peroxide initiator was excluded, the PVC resin formula and the processing conditions used herein were identical to those of Example 1.

Physical properties of the obtained PVC resin composition were measured and are reflected in Table 2.

### Comparative Example 1

From Table 1, except that vinyltrimethoxysilane as the coupling agent and the dicumyl peroxide initiator were excluded, the PVC resin formula and the processing conditions used herein were identical to those of Example 1.

Physical properties of the obtained PVC resin composition were measured and are reflected in Table 2.

### Comparative Example 2

From Table 1, the PVC resin formula used was the same as that of Comparative Example 1, but 25 weight parts of chlorided polyethylene elastomer as the toughening agent of Comparative Example 1, an approximate amount of inorganic powders (including 100 weight parts of aluminum hydroxide, 5 weight parts of zinc borate, 5 weight parts of molybdenum trioxide and 2 weight parts of montmorillonite) were beforehand mixed and then gelatinized to form a masterbatch under the processing conditions as shown in Table 2.

The obtained masterbatch was mixed by proportion with 100 weight parts of the PVC resin (average DP of 1000), 0.5 weight parts of the calcium-zinc stabilizer, 20 weight parts of the trioctyl trimellitate (TOTM) plasticizer and 0.2 weight parts of polyethylene wax as the lubricant. The mixture was gelatinized to form the PVC resin composition under the processing conditions as shown in Table 2.

Physical properties of the obtained PVC resin composition were measured and are reflected in Table 2.

### Comparative Example 3

From Table 1, one hundred weight parts of PVC resin (average DP of 1000), 0.5 weight parts of the calcium-zinc stabilizer, 15 weight parts of the trioctyl trimellitate (TOTM) plasticizer, 0.2 weight parts of polyethylene wax as the lubricant, 24 weight parts of tetrabromobisphenol-A (TBBPA), 8 weight parts of antimony trioxide as the flame retardant finishing agent, were weighted and put together into a vertical mixer for a mixing process under 60 rpm×10 min and the room temperature.

The mixture was then put into a kneader for a gelatinization process under 160° C.×45 rpm×25 min. After gelatinization, the gelatinized mixture was taken out from the kneader, and put into a single-screw extruder for a forming process under 160° C. The extruded mixture was then process by compulsory air-cooling and finished as a PVC resin composition.

Physical properties of the obtained PVC resin composition were measured and are reflected in Table 2.

### Results

By comparing the results of Examples 1 and 2 to Comparative Examples 1 to 3 as shown in Tables 1 and 2, the following conclusions have been drawn:

1. Comparative Example 3 is related to the conventional high-flame-retardancy PVC resin formula, which relied on the bromine-based flame retardant in cooperation with the antimony-based flame retardant to achieve high flame retardancy. Although it presented desirable flame retardancy with relative lower use of the brominated and antimony-based flame retardants while not compromising the mechanical properties of the product, it had considerable smoke generation.

2. Comparative Example 1 was made from the PVC resin formula with inorganic powders directly added. The composition showed high flame retardancy and low smoke generation, whereas the mechanical properties of PVC products made therefrom were compromised.

3. Example 1 depended on the PVC resin formula containing the inorganic powders in the presence of the coupling agent and the initiator. In addition to its high flame retardancy and low smoke generation, as compared with Comparative Example 1, the composition of Example 1 endowed its PVC products with significantly improved tensile strength and elongation.

4. Example 2 depended on the PVC resin formula identical to that of Example 1, yet with the elastomer, toughening agent, inorganic powders, coupling agent and the peroxide initiator in the formula made into a masterbatch prior to their mixing with the other components in the formula (Including the PVC resin, stabilizer, plasticizer, and the lubricant). The mixed masterbatch and the other components were then gelatinized to form the composition.

PVC products made of the composition showed high flame retardancy and low smoke generation, and had mechanical properties even more excellent as compared with those of the PVC products of Example 1.

5. Comparative Example 2 shared the same PVC resin formula and processing method with Example 2, except that the coupling agent and the initiator used in Example 2 were excluded. According to the physical properties shown in Table 2, it is found that the PVC products of Example 2 had better tensile strength and elongation.

6. Example 3 shared the same PVC resin formula and processing method with Example 1, except that the dicumyl peroxide initiator was excluded from the formula. According to the physical properties shown in Table 2, it is found that the PVC products of Example 3 had improved elongation but had tensile strength less improved as compared with Example 1.

TABLE 1
Formulas of Examples 1-3 and Comparative Examples 1-3

| | | | Example/Comparative Example | | | | | |
|---|---|---|---|---|---|---|---|---|
| | | | | | | Comparative | | |
| | | | Example | | | Example | | |
| | | | 1 | 2 | 3 | 1 | 2⁽⁷⁾ | 3 |
| Formula | PVC Resin | Average DP | 100 | 100 | 100 | 100 | 100 | 100 |
| | | of 1000 | | | | | | |
| | Heat Stabilizer | Calcium-Zinc | 0.5 | 0.5 | 0.5 | 0.5 | 0.5 | 0.5 |
| | Plasticizer | Trioctyl Trimellitate | 20 | 20 | 20 | 20 | 20 | 15 |
| | | (TOTM) | | | | | | |
| | lubricant | Polyethylene Wax | 0.2 | 0.2 | 0.2 | 0.2 | 0.2 | 0.2 |
| | Elastomer | Chlorided Polyethylene | 25 | 25 | 25 | 25 | 25 | 25 |
| | Toughening Agent | (Chlorine Content 42%) | | | | | | |
| | Inorganic Powders | Aluminum Hydroxide | 100 | 100 | 100 | 100 | 100 | — |
| | | Zinc Borate | 5 | 5 | 5 | 5 | 5 | — |
| | | Molybdenum Trioxide | 5 | 5 | 5 | 5 | 5 | — |
| | | Montmorillonite | 2 | 2 | 2 | 2 | 2 | — |
| | Coupling Agent | Vinyltrimethoxysilane | 2 | 2 | 2 | — | — | — |
| | Initiator | Dicumyl Peroxide | 0.1 | 0.1 | — | — | — | — |
| | Brominated Flame | Tetrabromobisphenol- | — | — | — | — | — | 24 |
| | Retardant | A (TBBPA) | | | | | | |
| | Antimony-Based | Antimony Trioxide | — | — | — | — | — | 8 |
| | Flame Retardant | | | | | | | |

| | | | | | | |
|---|---|---|---|---|---|---|
| Sum⁽¹⁾ | 259.8 | 259.8 | 259.7 | 257.7 | 257.7 | 172.7 |

TABLE 2
Physical Properties of Examples 1-3 and Comparative Examples 1-3

| | | | | | | | Comparative | | |
|---|---|---|---|---|---|---|---|---|---|
| | | | | Example | | | Example | | |
| Measurement | | | | 1 | 2 | 3 | 1 | 2⁽⁷⁾ | 3 |
| Physical | Tensile Strength⁽²⁾ (psi) | | | 2850 | 3210 | 2450 | 2120 | 2480 | 2630 |
| Properties | Elongation⁽²⁾ (%) | | | 250 | 280 | 245 | 170 | 225 | 252 |
| | Flame Retardancy⁽³⁾ (LOI) | | | 60.8 | 61.4 | 60.3 | 58.4 | 59.2 | 60.5 |
| | Smoke | Flame | Specific | 96 | 95 | 97 | 104 | 101 | 290 |
| | Density⁽⁴⁾ | Non-Flame | Optical | 124 | 119 | 122 | 136 | 128 | 452 |
| | | | Density⁽⁵⁾ | | | | | | |
| | | | (Ds) | | | | | | |

| | | | | |
|---|---|---|---|---|
| Processing | Sequence | Machine | Purpose | Processing Parameter |
| Conditions | 1 | Vertical | Well Mixing | 60 rpm × 10 min |
| | | Mixer | | |
| | 2 | Kneader | Thermal | 160° C. × 45 rpm × 25 min |
| | | | Gelatinization | |
| | 3 | Single-Screw | Extrusion | 160° C. × 15 rpm; Air Cooling |
| | | Extruder | | |

Note:
⁽¹⁾The amounts referred in the formula were measured in the unit of PHR (PHR = 1 part by weight per 100 parts by weight resin).
⁽²⁾The physical properties were measured and determined according to ASTM D-638 Standard Test Method.
⁽³⁾The flame retardancy (LOI) was measured and determined according to ASTM D-2683 Standard Test Method.
⁽⁴⁾The smoke density was measured and determined according to ASTM E-662 Standard Test Method.
⁽⁵⁾The specific optical density is known as smoke density.
⁽⁶⁾In the formula, the elastomer, inorganic powders, coupling agent, and the initiator were mixed beforehand and then gelatinized to form a masterbatch. The masterbatch was then mixed with the PVC resin, the stabilizer, the plasticizer, and the lubricant, and the resultant mixture was gelatinized and formed into the composition.
⁽⁷⁾In the formula, the elastomer and the inorganic powders were mixed beforehand and then gelatinized to form a masterbatch. The masterbatch was then mixed with the PVC resin, the stabilizer, the plasticizer, and the lubricant, and the resultant mixture was gelatinized and formed into the composition.

What is claimed is:

1. A PVC resin composition having feature of high flame retardancy and low smoke generation as well as high tensile strength and elongation, by weight of the composition comprising:
(a) 20% to 60% of a PVC resin prepared by polymerizing vinyl chloride monomer and having an average degree of polymerization ranging between 400 and 2000;
(b) 5% to 70% of inorganic powders acting as a flame retardant and having an average powder diameter ranging between 0.01 μm and 50 μm;
(c) 5% to 10% of a finishing agent selected one or more from the group consisting of a heat stabilizer, a plasticizer, a lubricant, an anti-oxidant, an antistatic agent, an ultraviolet absorber and a colorant;
(d) 1% to 50% of a toughening agent for improving the toughness of the PVC resin composition;
(e) 0.1% to 5% of a coupling agent for modifying the surface of the inorganic powders; and
(f) at most 5% of an initiator for cooperating with the coupling agent to improve the binding of the inorganic powders inside the PVC resin composition.

2. The PVC resin composition as defined in claim 1, wherein the inorganic powders is selected from the group consisting of aluminum hydroxide, aluminum oxide, aluminum oxalate, aluminum phosphate, aluminum sulfate, aluminum carbonate, magnesium hydroxide, magnesium oxide, magnesium phosphate, magnesium sulfate, magnesium carbonate, zinc borate, zinc oxide, zinc sulfate, zinc acetylacetonate, boron oxide, ammonium pentaborate, boron phosphate, boric acid, sodium borate, borates, calcium borate, calcium carbonate, calcium hydroxide, calcium acetylacetonate, molybdenum trioxide, calcium molybdate, zinc molybdate, ammonium octamolybdate, melamine octamolybdate, antimony trioxide, antimony pentoxide, antimonates, silica, silicone, silica gel, silicates, ferric oxide, ferrocene, benzoyl ferrocene, iron acetylacetonate, copper oxide, copper chloride, copper bromide, copper oxalate, zinc stannate, hydrated zinc stannate, titanium dioxide, aluminium titanate, mica, hydrotalcite, montmorillonite and combination thereof.

3. The PVC resin composition as defined in claim 1, wherein the toughening agent is selected from the group consisting of chlorided polyethylene elastomer, PVC-rubber graft copolymer, PVC-rubber copolymer, thermoplastic polyurethane elastomer, polyurethane elastomer, ethylene-vinyl-acetate elastomer, acrylic resin elastomer, acrylonitrile-butadiene-styrene elastomer, methyl-butadiene-styrene elastomer, styrene-butadiene-styrene elastomer, styrene-isoprene-styrene elastomer; styrene-ethylene-butylene-styrene elastomer, styrene-ethylene-propylene-styrene elastomer, thermoplastic olefin elastomer, thermoplastic dynamic vulcanized olefin elastomer, acrylonitrile-butadiene-rubber, polymethyl methacrylate resin, ethylene propylene diene monomer and any combination thereof.

4. The PVC resin composition as defined in claim 1, wherein the coupling agent is a silane-base coupling agent or a titanate-based coupling agent, used either solely or in combination.

5. The PVC resin composition as defined in claim 4, wherein the silane-base coupling agent is selected from the group consisting of 3-mercaptopropyltrimethoxysilane, 2-vinylphenyl-ethyl-trimethoxysilane, N-β-aminoethyl-γ-aminopropyl-trimethoxysilane, β-(3,4-epoxycyclohexyl)ethyltrimethoxysilane, γ-(glycidoxypropyl)trimethoxysilane, phenyltrimethoxysilane, vinyltrimethoxysilane, vinyltriethoxysilane and dimethyldimethoxysilane, either used solely or in combination.

6. The PVC resin composition as defined in claim 4, wherein the titanate-base coupling agent is selected from the group consisting of isopropyl triisostearoyl titanate, isopropyl trioctanoyl titanate, isopropyl tri(dioctylpyrophosphate)titanate, isostearoyl tri(dimethylpropylene)isopropyl titanate, isopropyl tri(N,N-2-aminoethyl)titanate, isopropyl tri(dodecylbenzenesulfonic)titanate, isopropyl isostearamidopropyl titanate, isopropyl tri(di(2-Ethylhexyl)phosphate)titanate, isopropyl tricumylphenyl titanate, di(di(2-ethylhexyl)phosphate)tetraisopropyl titanate, di(di(dodecyl)phosphate)tetra(2-ethylhexyl)titanate, di(di(tridecane)phosphate tetra(2,2-dimethyldi(allyloxy)-1-butyl)titanate, di(dioctylpyrophosphato)acetate titanate and di(dioctylpyrophosphato)ethylene titanate, either used solely or in combination.

7. The PVC resin composition as defined in claim 1, wherein the initiator includes a peroxide initiator, an azo-compound initiator or a redox-system initiator, either used solely or in combination.

8. The PVC resin composition as defined in claim 7, wherein the peroxide initiator is selected from the group consisting of dicumyl peroxide (DCP), 2,5-dimethyl-2,5-bis(t-butylperoxy)-hexyne (DBPH), 1,1-di-t-butylperoxy-3,3,5-trimethyl-cyclohexane, t-butylcumyl peroxide, 4,4-di-t-butylperoxy-n-butyl valerate, dibenzoyl peroxide (BPO), bis(2,4-dichlorobenzoyl)peroxide (DCBP), tert-butyl peroxypivalate (BPP), dicyclohexyl peroxydicarbonate (DCPD), potassium persulfate (KSP) and ammonium persulfate (ASP), either used solely or in combination.

9. The PVC resin composition as defined in claim 7, wherein the azo-compound initiator is a 2,2′-Azo-bis-isobutyronitrile (AIBN) or an azobisisoheptonitrile (ABVN), either used solely or in combination.

10. The PVC resin composition as defined in claim 7, wherein the oxidant for the redox-system initiator is a hydrogen peroxide, a persulfate, a hydroperoxide, an alkyl peroxide or an acetyl peroxide, and the reducing agent for the redox-system initiator is selected from the group consisting of alcohol, amine, oxalic acid, glucose, tertiary amine, naphthenate, thiol, organic metal compounds and combination thereof.

11. The PVC resin composition as defined in claim 1, wherein the heat stabilizer is selected one or more from ZnSt, CaSt, BaSt, CdSt, PbSt, sulfur-containing organo tin, organotin-carboxylate, tribasic lead sulfate, dibasic lead phosphate, dibasic lead stearate, lanthanum, cerium, praseodymium, and neodymium, wither in the form of a simple or a complex, a phosphate heat stabilizer, soybean oil epoxide or epoxy ester, pentaerythritol, xylitol or mannitol.

12. The PVC resin composition as defined in claim 1, wherein the plasticizer is selected one or more from dioctyl phthalate (DOP), n-hexyl-n-decyl phthalate (NHDP), n-octyl-ndecyl phthalate (NODP), di(isononyl)phthalate (DINP), di(isodecyl)phthalate (DIDP), diundecyl phthalate (DUP), di(isotridecyl)phthalate (DTDP), di-2-ethylhexyl adipate (DOA), di-n-oetyl-n-ducyl adipate (DNODA), diisononyl adipate (DINA), di-2-ethylhexyl azelate (DOZ), di-2-ethylhexyl sebacate (DOS), trioctyl trimellitate (TOTM), trioctyl phosphate (TOP), tricresyl phosphate (TCP), aliphatic polyester plasticizer or aliphatic polyol plasticizer.

13. The PVC resin composition as defined in claim 1, wherein the lubricant is selected from the group consisting of a stearic acid lubricant, a fatty acid lubricant, an alkanol amide lubricant, an ester lubricant, a metal soap lubricant and an organic silicon lubricant, either used solely or in combination.

14. The PVC resin composition as defined in claim 1, wherein the anti-oxidant may include a hindered phenol anti-oxidant or a phosphite anti-oxidant, either used solely or in combination.

15. The PVC resin composition as defined in claim 1, wherein the antistatic agent is selected from a surfactant, a conductive fibre, a conductive carbon or a metal powders, either used solely or in combination.

16. The PVC resin composition as defined in claim 1, wherein the ultraviolet absorber is selected from a benzophenone, a benzotriazole or a hindered amine ultraviolet absorber, either used solely or in combination.

17. The PVC resin composition as defined in claim 1, wherein the colorant is selected from an organic coloring agent or an inorganic coloring agent, either used solely or in combination.

18. A PVC product made of the PVC resin composition of claim 1 is a building material, a pipe, a mechanical part, an electric cord, an electric cable, an adhesive tape, plastic leather or fabric.
